(19) United States
(12) Patent Application Publication
(10) Pub. No.: US 2003/0046712 A1
(43) Pub. Date: Mar. 6, 2003

(54) Video transmission system having a plurality of transmission frame buffers

(76) Inventor: Koji Masuda, Kodaira (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/229,222

(22) Filed: Aug. 28, 2002

(30) Foreign Application Priority Data
Aug. 31, 2001 (JP) 2001-263284

(51) Int. Cl. H04N 7/16

(52) U.S. Cl. 725/144; 725/143; 725/145; 725/151; 725/147

(57) ABSTRACT

A video data transmission system in which a video signal transmitting apparatus and a plurality of video signal receiving apparatuses are coupled to each other via a network, and the video signal transmitting apparatus has a first memory unit for storing a video signal as digital video data which is sequentially updated a plurality of second memory units to which the digital video data is written at predetermined timings and from which the digital video data is read and a control unit for controlling the first and second memory units and a transmitter for transmitting the digital video data to the network. With the configuration, optimum digital video data is transmitted to the plurality of video signal receiving apparatuses in accordance with the transmission band of the network coupled to the video signal transmitting apparatus.

### BACKGROUND OF THE INVENTION

The present invention relates to a video transmission system and, more particularly, to a video transmission system for transmitting video data from a video signal transmitting apparatus having a plurality of transmission frame buffers to a plurality of video signal receiving apparatuses via a network.

FIG. 7 is a block diagram showing a conventional video transmission system.

FIG. 8 is a diagram showing an operation flow of transmitting/receiving frame video data which is video data obtained by converting a video signal picked-up by a camera on a video frame basis in the video transmission system shown in FIG. 7.

In FIG. 7, 101a, 101b, . . . , and 101s denote video signal transmitting apparatuses which will be generically called a video signal transmitting apparatus 101 when the apparatuses are not necessarily distinguished from each other. The video signal transmitting apparatus 101 converts a video signal obtained from cameras 103a, 103b, . . . , and 103s (generically called a camera 103 when they are not necessarily distinguished from each other) to digital video data on a video frame basis by a video data converter 116 and stores the digital video data to a frame video data buffer 114. The video signal transmitting apparatus 101 has a function of transmitting frame video data in the frame video data buffer 114 to a network 100 (including links 100a, 100b, . . . and 100x unless otherwise specified) in response to a request of transmitting the video signal from the outside. 102a, 102b, . . . , and 102n denote video signal receiving apparatuses which have a function of transmitting a transmission request to the network 100, receiving the frame video data from the video signal transmitting apparatus 101, converting the frame video data into a video signal, and outputting the video signal to monitors 350a, 350b, . . . , and 350n. The video signal receiving apparatus and the monitor will be generically called a video signal receiving apparatus 102 and a monitor 350 when they do not have to be necessarily distinguished among themselves.

The configuration and operation of the video signal transmitting apparatus 101 will be described by taking the video signal transmitting apparatus 101a as an example. The video signal transmitting apparatus 101a is constructed by the video data converter 116, a controller 117, frame video data buffer 114, a receiver 111, and a plurality of transmitters 112-1, 112-2, and 112-p. A video signal 103aa from the camera 103a is converted into digital video data 121 by the video data converter 116. As the digital video data 121, non-compressed video data 121 may be used. When there is a compressing function, compressed digital video data 121 may be used. In the case of compressing video data, there are advantages such that the memory capacity in the case of storing a video signal can be reduced and, when the video signal is transmitted, a transmission band may be narrow. In order to compress video data, for example, systems such as MPEG (Moving Picture Experts Group) of ISO/IEC and ITU-T recommendation H.261/H.263 of international organizations for standardization can be used.

The digital video data 121 is, for example, digital frame video data of 30 frames/second or 24 frames/second and is successively recorded into the frame video data buffer 114 via the controller 117. The frame video data buffer 114 takes the form of a buffer memory of a type in which the latest video data picked-up by the camera 103 is always overwritten, thereby always updating video data.

When transmission request information 111a from one of the video signal receiving apparatuses 102, for example, the video signal receiving apparatus 102a is received via the receiver 111, the controller 117 reads out the frame video data 121 already recorded from the frame video data buffer 114 and outputs it to the transmitter 112-1 via a bus 115. The controller 117 controls the transmitter 112-1 and distributes the frame video data 121 from the transmitter 112-1 to the video signal receiving apparatus 102a which has sent the transmission request at a predetermined timing in accordance with a predetermined communication protocol. The controller 117 has a function of, when there are transmission requests of the frame video data 121 from the plurality of video signal receiving apparatuses 102, selecting the transmitter 112 which is available among the plurality of transmitters 112-1 to 112-p and distributing the data in accordance with the reception order of the transmission request information 111a.

The video transmission system will be further described in more detail. As communication protocols used for transmitting/receiving the frame video data, the TCP/IP (Transmission Control Protocol/Internet Protocol), UDP/IP (User Datagram Protocol/Internet Protocol), or the like is often used.

The case where the video signal receiving apparatus 102a displays the frame video data 121 sent from the video signal transmitting apparatus 101a on the monitor 350a will be described. The video signal receiving apparatus 102a transmits the transmission request information 111a to the video signal transmitting apparatus 101a via the network 100. When the transmission request information 111a is received via the network 100 and the receiver 111, the controller 117 of the video signal transmitting apparatus 101a reads the frame video data 121 stored in the frame video data buffer 114 and transfers it to the transmitter 112-1 via the bus 115. Simultaneously, the controller 117 records the next frame video data from the camera 103a into the frame video data buffer 114, thereby updating the data recorded in the frame video data buffer 114. The transmitter 112-1 transmits the frame video data 121 to the video receiving apparatus 102a via the network 100.

When the frame video data is received via the network 100, the video signal receiving apparatus 102a performs a data processing process inverse to the data conversion performed by the video data converter 116 of the video signal transmitting apparatus 101a by a video data converter (not shown) of the video signal receiving apparatus 102a, and outputs the resultant as a video signal to the monitor 350a via a transmission path 102aa.

Further, the video signal receiving apparatus 102a transmits the transmission request information 111a of the next frame video data to the video signal transmitting apparatus 101a at a predetermined timing in the reception period of the frame video data. A transmission request of the frame video data 121 is sent also from another one of the video signal receiving apparatuses 102b, . . . , and 102n to the video signal transmitting apparatus 101a, and an operation of transmitting/receiving the frame video data is performed between the video signal transmitting apparatus 101a and the video signal receiving apparatus 102.

The operation of transmitting/receiving the frame video data will be described by referring to FIG. 8. In FIG. 8, the video signal 103aa from the camera 103a is converted to digital frame video data by the video data converter 116 in a video frame period T1, thereby obtaining the frame video data 121 (indicated by reference character A) as shown in (a) in FIG. 8. The frame video data A is stored in the frame video data buffer 114 as shown by (b) in FIG. 8. At timings of time slots t1 and t4 in the video frame period T1, the transmission request information 111a shown by (c) in FIG. 8 is supplied from the video signal receiving apparatuses 102d and 102c to the controller 117. The transmission request information 111a is held in a memory unit (not shown) of the controller 117. Until the frame video data 121 is transmitted to the video signal receiving apparatus 102d, for example, the transmission request information 111a is stored in the memory and is not reset. (c) in FIG. 8 shows such a state. Specifically, in FIG. 8, characters (hatched portion) in square boxes, for example, 1 to 5 are ID numbers assigned to the video signal receiving apparatuses 102a, 102b, . . . , and 102e. For example, when five video signal receiving apparatuses are provided, ID-1, ID-2, . . . , and ID-5 are assigned to the video signal receiving apparatuses 102a, 102b, . . . , and 102e, respectively. Therefore, in the video frame period T1, a transmission request of the frame video data A is sent from the video signal receiving apparatus 102d at the time slot t1, and a transmission request of the frame video data A is sent from the video signal receiving apparatus 102c at time slot t4. A rectangular blank box denotes that the transmission request information 111a is held in the memory unit in the controller 117.

In the description, to simplify the description, the video frame period is divided into four time slots t1, t2, t3, and t4 which are schematically expressed. In the actual system, such time slots are not provided. This will be described later.

In the following video frame period T2, the controller 117 reads out the data A, that is, the frame video data 121 from the frame video data buffer 114, and transmits the frame video data 121 indicated by A to the video signal receiving apparatus 102d having the ID of 4 and the video signal receiving apparatus 102c having the ID of 3 via the transmitter 112-1 with transmission time Tx as shown in (d) in FIG. 8. In the video frame period T2, although the latest frame video data B is input from the camera 103a, the controller 117 transmits the frame video data 121 indicated by A, as a result, the frame video data A is kept in the frame video data buffer 114, and is not updated by the video data B. On the other hand, in the video frame period T2, it is shown that the video data transmission request is newly sent from each of the video signal receiving apparatuses 102d, 102a, and 102c (having ID numbers ID-4, ID-1, and ID-3, respectively).

In the video frame period T2, transmission of the video data A to the video signal receiving apparatuses 102d and 102c is finished. In the video frame period T3, the data of the frame video data buffer 114 is rewritten from A to C, so that the video data is not transmitted.

In the following video frame period T4, the controller 117 transmits the data C of the frame video data 121 to the video signal receiving apparatuses 102d, 102a, 102c, and 102e which have sent the video data transmission request in the video frame periods T2 and T3 with transmission time Tx, Ty, Tx, and Tz, respectively. The transmission time Tx, Ty, and Tz is, for example, 10.3 m sec, 42 m sec (transmission speed of 3 Mbps), and 63 m sec (transmission speed of 2 Mbps), respectively. The reason why the transmission speeds are various is that various transmission paths of different transmission speeds are connected to the network 100. For example, as high-speed transmission paths, 100 Base-T having a transmission speed of about 100 Mbps, an optical fiber cable having a transmission speed of 1 Gbps, and an ADSL (Asymmetric Digital Subscriber Line) having a transmission speed of 8 Mbps or 1.5 Mbps, and as low-speed transmission paths, an ISDN (Integrated Services Digital Network) of 64 Kbps, an analog transmission path of 56 Kbps, and the like mixedly exist in the network. Therefore, in the case of transmitting the video data C from the video signal transmitting apparatus 101a to the video signal receiving apparatus 102, it is necessary to distribute video data in accordance with the communication speed. Specifically, in the video frame period T4 in FIG. 8, the video data C has to be distributed at the transfer time Tx, Ty, an Tz, so that the video data C is distributed to the video signal receiving apparatuses 102 via the transmitter 112-1 (corresponding to the transmission time Tx), transmitter 112-2 (corresponding to the transmission time Ty), and transmitter 112-3 (corresponding to the transmission time Tz). This state is shown by (d), (ed), (ea), (ec), and (ee) in FIG. 8.

As obviously understood from FIG. 8, the transmission time Ty and Tz extends in the video frame periods T4 and T5, so that the frame video data buffer 114 continuously holds the video data C. Accordingly, video data D and E from the camera 103a is not recorded but deleted. A similar operation is repeated after that, and the frame video data is transmitted/received between the video signal transmitting apparatus 101 and the video signal receiving apparatus 102 in predetermined cycles.

The above-described conventional video transmission system can transmit the frame video data to the video signal receiving apparatuses as the plurality of transmission request sources. However, until the video transmission to the video signal receiving apparatus as the transmission request source which has sent the video data transmission request first is finished, transmission to the video receiving apparatus as the next transmission request source cannot be performed. There is also a problem such that although the camera picked-up the latest video data, the data in the frame video data buffer is not updated. Further, in a motion video, video data of a sufficient amount corresponding to a motion cannot be obtained, so that the video cannot be helped but becomes unnatural. In the case where a transmission path of a low transmission speed is connected to a network extending from the video signal transmitting apparatus 101 to the video signal receiving apparatus 102, there is a problem such that due to an influence of a transmission path of a low transmission speed, service to the user requiring high-speed distribution deteriorates.

### SUMMARY OF THE INVENTION

An object of the present invention is to provide a video data transmission system capable of sufficiently addressing video data transmission requests from a plurality of users.

Another object of the invention is to provide a video data transmission system capable of transmitting video data to a plurality of video signal receiving apparatuses irrespective of the transmission speed of a network.

Further another object of the invention is to provide a video data transmission system capable of sufficiently addressing a motion video.

To achieve the objects, a video data transmission system of the invention has at least one video signal transmitting apparatus for transmitting the video data to a network, a network connected to the video signal transmitting apparatus, for transmitting the video data and a plurality of video signal receiving apparatuses connected to the network, for receiving the video data. The video signal transmitting apparatus includes a first memory unit for storing the video data, a second memory unit for storing the video data, a plurality of transmitters for transmitting the video data stored in the first and second memory units to the network and a control unit for writing/reading the video data in the first and second memory units in accordance with a request of transmitting the video data from the video signal receiving apparatus, and controlling a transmitting operation of the plurality of transmitters.

The video signal transmitting apparatus used for the video data transmission system of the invention further includes a video data converter for converting the video signal to frame video data on a video frame basis, and is constructed so that the frame video data from the video data converter is stored in a vacant one of the first and second memory units.

When the video signal transmitting apparatus used for the video data transmission system according to the invention receives a request of transmitting the frame video data from at least one video signal receiving apparatus, the controller of the video signal transmitting apparatus reads the frame video data stored in the second memory unit and controls the transmitter to transmit the frame video data to the video signal receiving apparatus which has sent the transmission request.

The video signal transmitting apparatus used for the video data transmission system according to the invention further includes a video data converter for converting a video signal to frame video data basis, and is constructed so that frame video data from the video data converter is stored in the first memory unit, and the frame video data stored in the first memory unit is read and stored in a vacant memory unit in the plurality of second memory units.

When the video signal transmitting apparatus used for the video data transmission system according to the invention receives a request of transmitting the frame video data from at least one video signal receiving apparatus, the controller of the video signal transmitting apparatus reads out the frame video data stored in the first memory unit, stores the frame video data in a vacant one of the plurality of second memory units, and controls the transmitter to transmit the frame video data to the video signal receiving apparatus which has sent the transmission request.

The video data transmission system according to the invention further includes a camera unit coupled to the video signal transmitting apparatus and is constructed so that a video signal obtained from the camera unit is converted to frame video data by the video data converter and data recorded in the first memory unit is sequentially updated with the frame video data.

The controller of the video signal transmitting apparatus used for the video data transmission system according to the invention updates data recorded in the second memory units in accordance with updating of the data recorded in the first memory unit except for the second memory unit which transmits frame video data to the video signal receiving apparatus.

Further, in the video data transmission system according to the invention, when the number of the video signal receiving apparatuses is n and the number of the second memory units is m, the relation of n>m >0 (where n and m are positive integers) is satisfied.

In another embodiment of the invention, the number of the video signal receiving apparatuses and the number of the second memory units of the video signal transmitting apparatus are equal to each other.

Further, a video data transmission system of the invention includes a video signal transmitting apparatus for converting a video signal to video data and outputting the video data to a network, and a video signal receiving apparatus for receiving the video data from the network. The video signal transmitting apparatus stores the video data as frame video data basis of the video signal into a first memory unit, when a request of transmitting the frame video data is received from the video signal receiving apparatus, reads out the frame video data stored in the first memory unit, stores the read data into a vacant one of a plurality of second memory units, and transmits the frame video data to the video signal receiving apparatus which has sent the transmission request. The video receiving apparatus sends a request of transmitting the next frame video data when the frame video data is received.

Further, the video data transmitting apparatus of the invention has a video data converter for converting a video signal to video data in a video frame unit, a first memory unit for storing the video data, a second memory unit for storing the video data, a plurality of transmitters for transmitting the video data stored in the first and second memory units to the transmission path and a controller for writing/reading the video data in the first and second memory units in accordance with a request of distributing the video data from the transmission path, and controlling a transmitting operation of the plurality of transmitters.

The video signal transmitting apparatus of the invention has a video data converter for converting a video signal to frame video data and is constructed so that the frame video data from the video data converter is stored in a vacant memory unit of the first memory unit and the plurality of second memory units and the stored data is sequentially updated.

In the video signal transmitting apparatus of the invention, when a request of transmitting the frame video data is received from the transmission path, the controller reads out the frame video data stored in the second memory unit and controls the transmitter to transmit the frame video data to the transmission path.

The video signal transmitting apparatus of the invention has a video data converter for converting a video signal to frame video data and is constructed so that the frame video data from the video data converter is stored into the first memory unit, the stored data is sequentially updated, and the controller reads the frame video data stored in the first memory unit, stores the read data to a vacant one of the plurality of second memory units, and controls the transmitter to transmit the frame video data to the video signal receiving apparatus which has sent the transmission request.

The above and other objects, features and advantages of the present invention will be apparent from the following detailed description of illustrative embodiments which is to be read in connection with the accompanying drawings.

### BRIEF DESCRIPTION OF THE DRAWINGS

FIG. 1 is a block diagram showing an embodiment of the present invention.

FIG. 2 is a block diagram showing an embodiment of a video signal transmitting apparatus used for the present invention.

FIG. 3 is a block diagram showing an embodiment of a video signal receiving apparatus used for the present invention.

FIG. 4 is a diagram showing a time chart for explaining operations of the embodiment of the present invention.

FIG. 5 is a diagram showing a time chart for explaining detailed operations of the embodiment of the present invention.

FIG. 6 is a diagram showing a time chart for explaining operations of another embodiment of the present invention.

FIG. 7 is a block diagram showing an example of a conventional video transmission system.

FIG. 8 is a diagram showing a time chart for explaining operations of an example of the conventional video transmission system.

### DETAILED DESCRIPTION OF THE ILLUSTRATED EMBODIMENTS

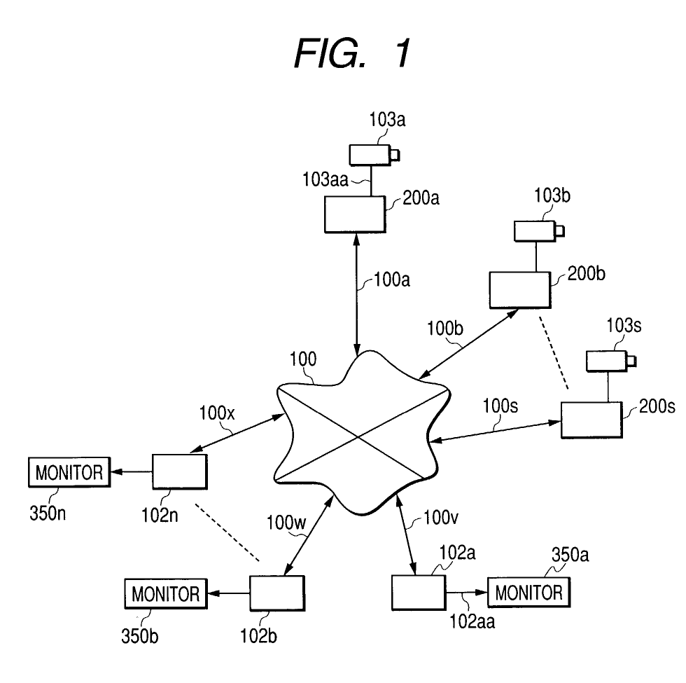

A first embodiment of the present invention will be described by referring to FIGS. 1, 2, 3, and 4.

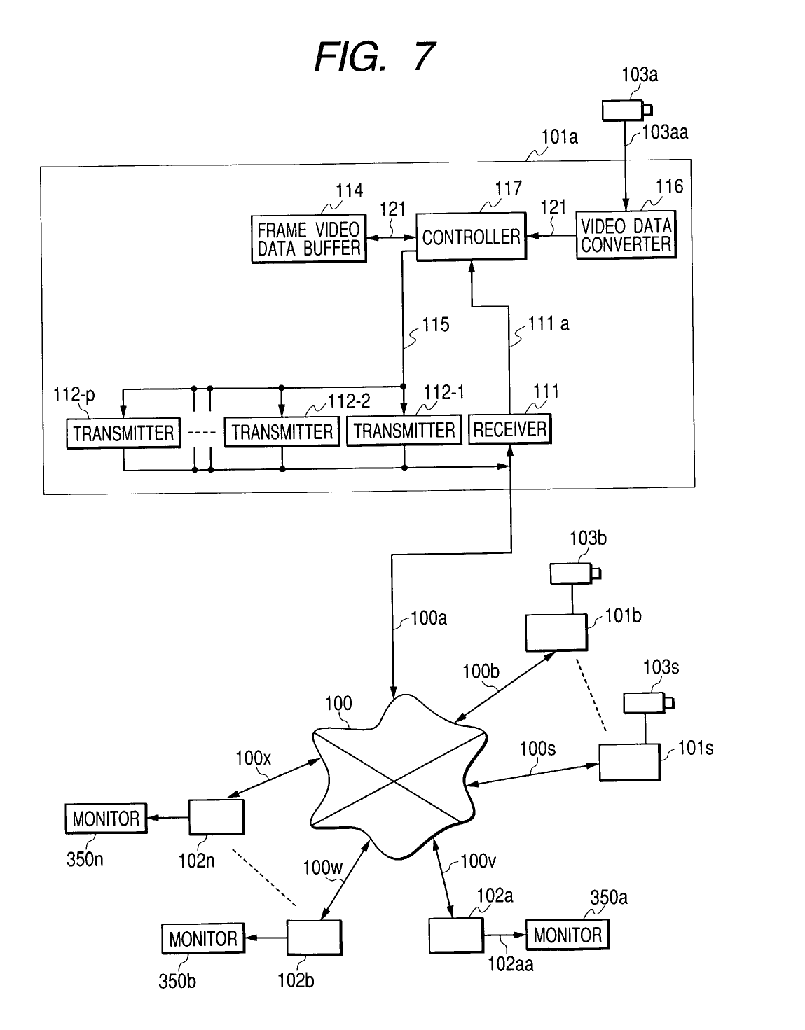

FIG. 1 is a block diagram of a video transmission system of the first embodiment of the present invention. In FIG. 1, 200a, 200b, . . . , and 200s denote video signal transmitting apparatuses which will be generically called video signal transmitting apparatuses 200 when they do not have to be necessarily distinguished from each other. The same components as those in FIG. 7 are designated by the same reference numerals.

In FIG. 1, a video signal picked-up by the camera 103 is digitized by the video signal transmitting apparatus 200 and stored as frame video data. The frame video data is sequentially updated to the latest frame video data.

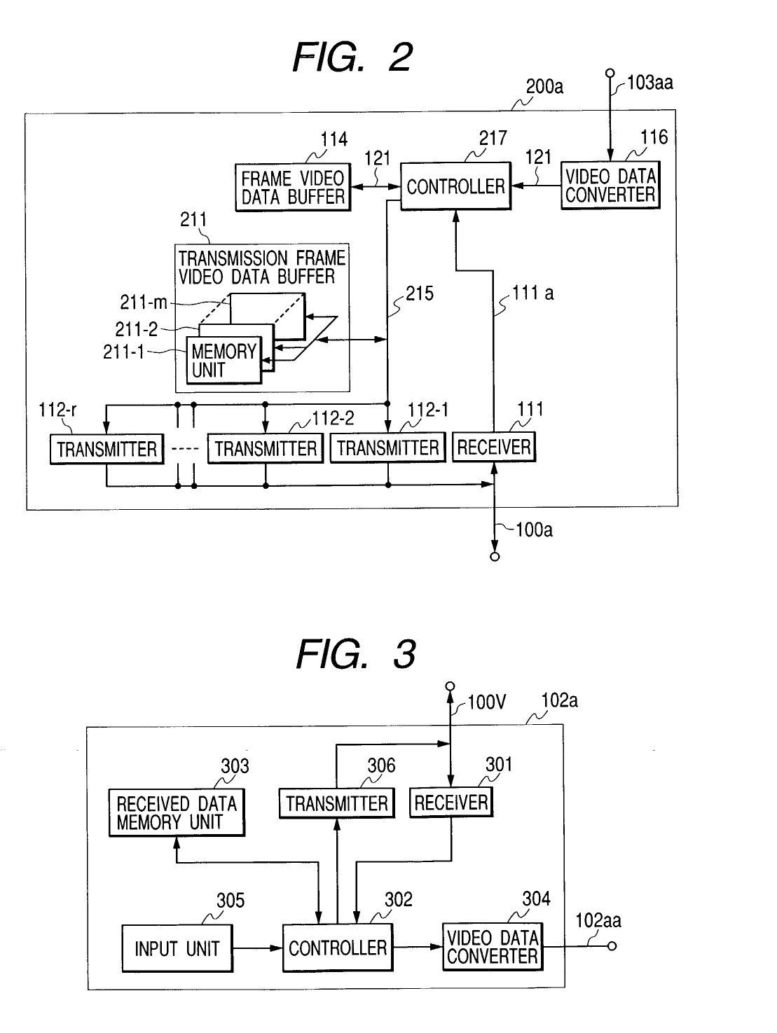

On the other hand, when transmission requests of frame video data are sent from some of the plurality of video signal receiving apparatuses 102 to the video signal transmitting apparatus 200, in accordance with the transmission request, the latest frame video data stored in the video signal transmitting apparatus 200 is distributed to each of the video signal receiving apparatuses 102 which sent the transmission request. The details will be described by referring to FIGS. 2 and 3.

FIG. 2 is a block diagram showing an embodiment of one of the video signal transmitting apparatuses 200, for example, the video signal transmitting apparatus 200a. In FIG. 2, 211 denotes a transmission frame video data buffer having m pieces of memory units 211-1, 211-2, . . . , and 211-m. 112-1, 112-2, . . . , and 112-r denotes r pieces of transmitters. m and r may be the same number. Depending on the configuration of the network 100, different values may be set. The number n of the video signal receiving apparatuses 102 and the number m of the memory units are integers satisfying the relation of n>m>1. 215 denotes a bus line which is used to transmit/receive signals such as a control signal and video data among a controller 217, the transmission frame video data buffer 211, and the transmitter 112. The same components as those in FIG. 7 are designated by the same reference numerals.

FIG. 3 is a block diagram showing an embodiment of one of the video signal receiving apparatuses 102, for example, the video signal receiving apparatus 102a. Shown in FIG. 3 are a receiver 301, a controller 302, a received data memory unit 303, a video data converter 304, an input unit 305, and a transmitter 306.

The operation of the present invention will be described. The video signal 103aa picked-up by the camera 103a is converted into the digital frame video data 121 on a video frame basis by the video data converter 116 and the digital frame video data 121 is recorded into the frame video data buffer 114 via the controller 217. On the other hand, when the transmission request information 111a is supplied from the video signal receiving apparatus 102, for example, the video signal receiving apparatus 102a to the video signal transmitting apparatus 200a, the frame video data 121 is read out from the frame video data buffer 114 and recorded into a vacant memory unit in the transmission frame video data buffer 211 constructed by a plurality of memory units 211-1, 211-2, . . . , and 211-m via the bus 215. The controller 217 controls the transmitter 112-1 so as to output the frame video data 121 to the video receiving apparatus 102a as a transmission source of the transmission request information 111a at a predetermined timing. Via the bus 215, not only the frame video data 121 to be transmitted, but also the frame video data from the controller 217 to the transmission frame video data buffer 211 and reading/writing control information is transmitted. Also the control information to the transmitter 112 to perform transmission of the frame video data from the transmission frame video data buffer 211 to the transmitter 112 and transmission of the frame video data is transmitted in accordance with a predetermined communication protocol at a predetermined timing. The transmission frame video data buffer 211 is constructed by a plurality of memory units 211-1, 211-2, . . . , and 211-m to/from each of which frame video data is written/read at a predetermined timing via the bus 215 under control of the controller 217. As a communication protocol used to transmit/receive video data, in a manner similar to the above, TCP/IP, UDP/IP, or the like is used.

A case where the video signal receiving apparatus 102 requests the video signal transmitting apparatus 200a to send the frame video data, receives frame video data from the video signal transmitting apparatus 200a, and displays the frame video data onto the monitor 350a will be described. First, transmission request information of a request for transmission of frame video data is transmitted from the input unit 305 of the video signal receiving apparatus 102a via the controller 302, transmitter 306, and network 100 (including, unless otherwise specified, links 100a, 100b, . . . , and 100x).

The video signal transmitting apparatus 200a receives the transmission request information 111a via the network 100 and the receiver 111.

When the transmission request information 111a is received from the video signal receiving apparatus 102a, the controller 217 of the video signal transmitting apparatus 200a reads out the frame video data 121 stored in the frame video data buffer 114, and records it to any vacant one of the memory units 211-1, 211-2, . . . , and 211-m in the transmission frame video data buffer 211 via the bus 215.

Further, the controller 217 reads out the frame video data 121 stored in the transmission frame video data buffer 211 at a predetermined timing and transfers it to the transmitter 112-1 via the bus 215. The transmitter 112-1 receives the frame video data 121 and control information and transmits the frame video data 121 to the video signal receiving apparatus 102a as a transmitter of the transmission request information 111a via the network 100.

When the frame video data is received by the receiver 301 via the network 100, the video signal receiving apparatus 102a records received data into the received data memory unit 303 once, under control of the control unit 302, reads the frame video data from the received data memory unit 303, converts the read frame video data to a video signal by the video data converting unit 304, and outputs the resultant to the monitor 350a.

The video signal receiving apparatus 102a transmits the transmission request information of the next frame video data to the video transmitting apparatus 200a at a predetermined timing in the period of receiving the frame video data in accordance with the communication protocol.

Although the transmission request of the video signal receiving apparatus 102a has been described above, an operation is also performed in correspondence with a transmission request from any of the other video signal receiving apparatuses 102b, . . . , and 102n, and the video signal transmitting apparatus 101a performs operations of transmitting/receiving the frame video data to/from the plurality of video signal receiving apparatuses 102.

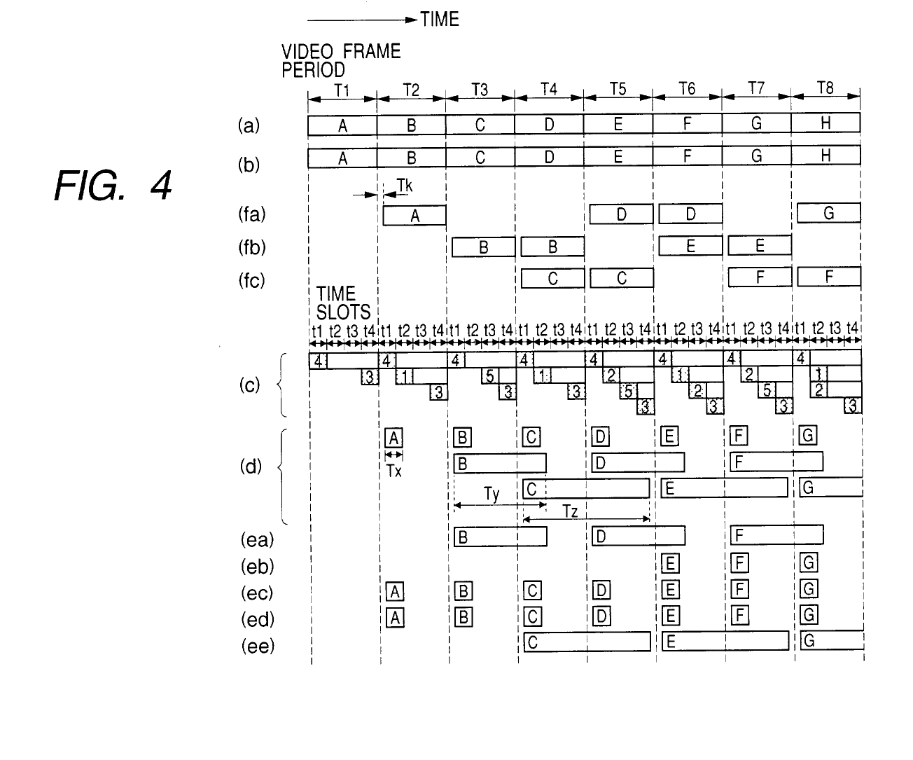

With reference to FIG. 4, the operations of transmitting/receiving the frame video data will be described in more detail. In FIG. 4, it is assumed that the video signal transmitting apparatus 200a transmits/receives frame video data to/from the five video signal receiving apparatuses 102a, 102b, 102c, 102d, and 102e (that is, n=5). The transmission frame video data buffer 211 has three memory units 211-1, 211-2, and 211-3 (that is, m=3). To simplify the following description, to indicate transmission requests of the transmission request information 111a from the video signal receiving apparatuses 102a, 102b, . . . , and 102e, ID numbers 1, 2, . . . , and 5 are assigned as shown in (c) of FIG. 4. Therefore, numbers of ID-1, ID-2, ID-3, ID-4, and ID-5 are assigned to the video signal receiving apparatuses 102a, 102b, 102c, 102d, and 102e, respectively. Description will be given on assumption that the transmission request information of the video signal receiving apparatuses 102a, 102b, . . . , and 102e is transmitted at predetermining timings of time slots t1, . . . , and t4 obtained by dividing a video frame period Tj (j=1, 2, . . . ) into four parts and, at the timings, the video transmitting apparatus 200a transmits the frame video data. In an actual system, the video frame period is not divided into time slots. The time slots are just schematically illustrated. This will be described hereinlater.

The memory units for storing the frame video data are the three memory units 211-1, 211-2, and 211-3. (fa), (fb), and (fc) in FIG. 4 corresponds to the memory units 211-1, 211-2, and 211-3, respectively. In response to the transmission request information from the video signal receiving apparatuses 102a, 102b, and 102e, the frame video data to be transmitted under control of the control unit 217 is recorded in any vacant one of the memory units 211a, 211b, and 211c. (fa), (fb), and (fc) in FIG. 4 show the storage state of frame video data in the memory units 211-1, 211-2, and 211-3, respectively. The transmission band of the transmission path to the video signal receiving apparatuses 102b, 102c, and 102d is sufficiently assured, and data is transmitted with transmission time Tx (period of one video frame>transmission time Tx>0), for example, 10.5 msec. To the video signal receiving apparatuses 102a and 102e, due to an insufficient transmission band, transmission time Ty or Tz (period of two video frames>transmission time Tz>transmission time Ty>period of one video frame) is required. Data is transmitted/received in the period of two video frames. For example, Ty is 42 msec and Tz is 63 msec.

In FIG. 4, in the video frame period T1, the video signal 103aa from the camera 103a is recorded on the frame video data buffer 114 (shown by (b) in FIG. 4) as the frame video data 121 indicated by A (shown in (a) in FIG. 4). In time slots t1 and t4 in the video frame period T1, as shown in (c) in FIG. 4, the transmission request information 111a from the video signal receiving apparatuses 102d (ID-4) and 102c (ID-3) is received by the controller 217.

In the following video frame period T2, the controller 217 stores the frame video data 121 indicated by A from the frame video data buffer 114 into the vacant memory unit 211-1 in the transmission frame video data buffer 211 via the bus 215 (illustrated by (fa) in FIG. 4). Simultaneously, the controller 217 reads out the frame video data 121 indicated by A stored in the memory unit 211-1 and transfers it to the transmitter 112-1 via the bus 215. The transmitter 112-1 receives the frame video data 121 indicated by A and control information of the controller 217 and transmits the frame video data A to the video receiving apparatuses 102d and 102c to which data is input in the preceding video frame period T1 at predetermined timings in accordance with a predetermined communication protocol as shown by (d) in FIG. 4. (ed) and (ec) in FIG. 4 indicate that the video signal receiving apparatuses 102d and 102c receive the frame video data A. In the video frame period T2, the latest frame video data 121 indicated by B from the camera 103a is written into the frame video data buffer 114 by the control of the controller 217, and the data in the frame video data buffer 114 is updated. Further, the frame video data is transmitted to the video signal receiving apparatuses 102d and 102c on start of the video frame period T2, so that the transmission request information of ID-4 and ID-3 in the controller 217 is reset. On the other hand, when the video signal receiving apparatuses 102d and 102c receive the frame video data A, the video signal receiving apparatuses 102d and 102c transmit transmission request information of the next frame video data in the predetermined time slots t1 and t4 in the video frame period T2, respectively. Further, in the time slot t2, the transmission request information from the video signal receiving apparatus 102a of ID-1 is newly received. Therefore, in the video frame period T2, the controller 217 receives the transmission request information 111a from the video signal receiving apparatuses 102d, 102a, and 102c.

In the video frame period T3, on start of the period T3, the controller 217 stores the frame video data 121 indicated by B from the frame video data buffer 114 into the vacant memory unit 211-2 in the transmission frame video data buffer 211 via the bus 215 with transmission time Tk as illustrated by (fb) in FIG. 4 and, simultaneously, transferred to the transmitter 112-2 via the bus 215. The transmitter 112-1 receives the frame video data 121 indicated by B and the control information of the control unit 217 and transmits the frame video data B to the video signal receiving apparatuses 102d, 102a, and 102c which have sent the transmission request in the preceding video frame period T2 with the transmission time Tx or Ty (illustrated by (d) in FIG. 4). Since the transmission time Ty to the video receiving apparatus 102a satisfies the relation of the period of two video frames>transmission time Ty>period of one video frame, as illustrated by (ea) of FIG. 4, the end of transmission of the frame video data to the video receiving apparatus 102a is in the following video frame period T4. Therefore, the data in the memory unit 211-2 is not updated but is held as the frame video data B as shown by (fb) in FIG. 4. In the video frame period T3, the controller 217 writes the latest frame video data 121 indicated by C into the frame video data buffer 114, thereby updating the data in the frame video data buffer 114. Further, the frame video data is transmitted to the video signal receiving apparatuses 102d, 102a, and 102c on start of the video frame period T3, so that the transmission request information ID-4, ID-1, and ID-3 in the controller 217 is reset. However, when the video signal receiving apparatuses 102d and 102c receive the frame video data B, the video signal receiving apparatuses 102d and 102c transmit the transmission request information of the next frame video data in the predetermined time slots t1 and t4 in the video frame period T3, respectively. Further, in the time slot t3, the transmission request information from the video signal receiving apparatus 102e is newly received. Therefore, in the video frame period T3, the controller 217 receives the transmission request information 111a from the video signal receiving apparatuses 102d, 102e, and 102c again.

In the video frame period T4, by an operation similar to the above, the frame video data 121 indicated by C stored in the vacant memory unit 211-3 is transmitted to the video signal receiving apparatuses 102d, 102e, and 102c which have sent a transmission request with transmission time Tx or Tz. Since the transmission time Tz to the video signal receiving apparatus 102e satisfies the relation of the period of two video frames>transmission time Tz>the period of one video frame, end of the transmission of the frame video data 121 indicated by C to the video signal receiving apparatus 102e is in the next video frame period T5 (indicated by (d) and (ee) in FIG. 4). When end of reception is determined around the time slot t2 in the video frame period T4, the video signal receiving apparatus 102a transmits the transmission request information of the next frame video data to the video signal transmitting apparatus 200a.

After that, similar operations are repeated, thereby transmitting the latest frame video data every video frame period to the video signal receiving apparatuses 102b, 102c, and 102d. To the video signal receiving apparatuses 102a and 102e, the frame video data 121 is transmitted every period of two video frames, and a reproduced video is displayed on the monitor 350.

According to the first embodiment of the invention, the transmission frame video data buffer 211 has a plurality of memory units, thereby enabling frame video data to be transmitted to the video signal receiving apparatus 102 with transmission time which is shorter or longer than the period of one video frame in accordance with the transmission speed of the transmission path extending from the video signal transmitting apparatus to the video signal receiving apparatus. When transmission time of the period of one video frame or longer is necessary, the frame video data is stored in the memory unit until the end of transmission and the latest frame video data is stored in another vacant memory unit, so that the process of transmitting the next frame video data can be addressed. Therefore, the video signal receiving apparatus can receive the latest frame video data every video frame period in accordance with the transmission band of the transmission path extending from the video signal transmitting apparatus to the video signal receiving apparatus, and optimum video reproduction with a natural motion can be realized.

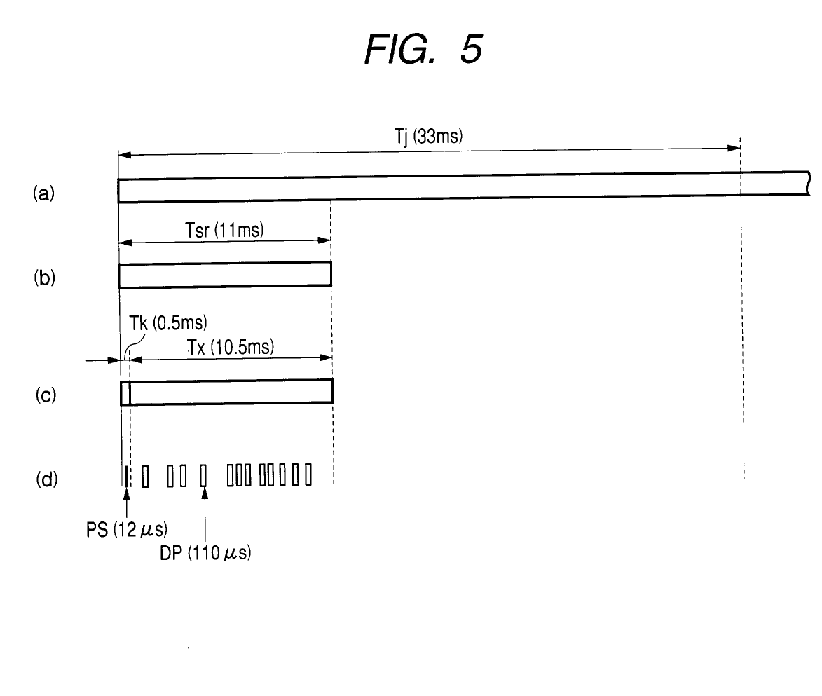

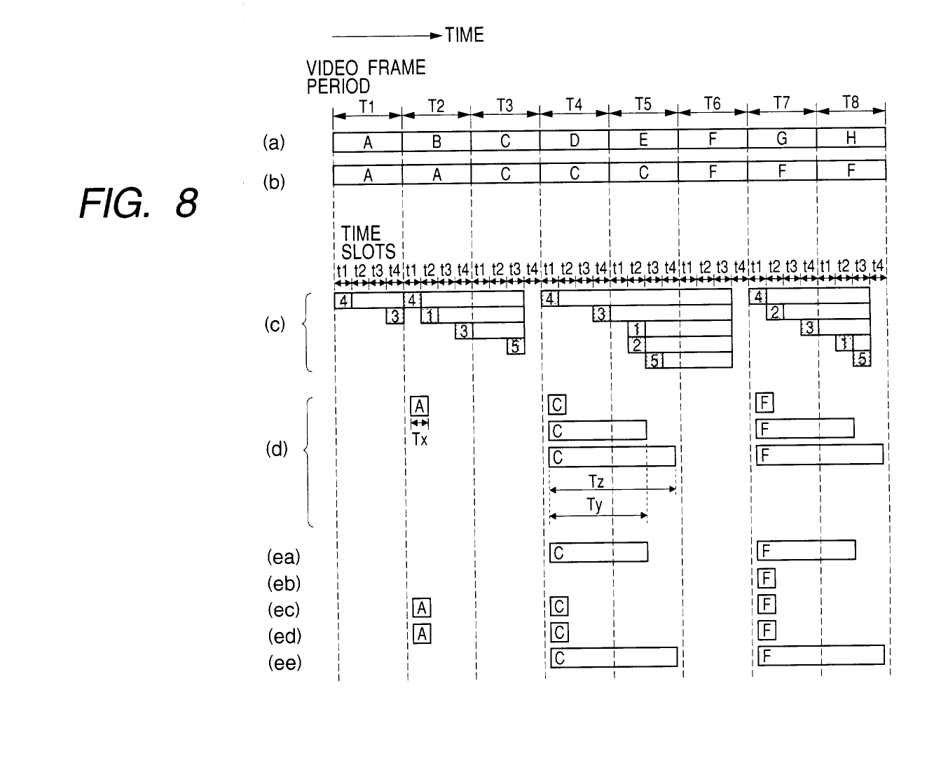

As described above, transmission and reception of the transmission request information and the frame video data shown in FIGS. 4 and 8 is schematically illustrated. Transmission and reception of the transmission request information and the frame video data in an actual communication system will be described by referring to FIG. 5. In the example described here, communication speed is 100 Mbps, video data is about 16 Kbytes, and the transmission protocols are HTTP and TCP/IP. However, those are changeable according to the data of a video and the invention is not limited to those parameters. In FIG. 5, (a) indicates a period of one video frame Tj (for example, 33 m sec) (j=1, 2, . . . ), (b) indicates a data transmission/reception period Trs (for example, 11 msec) and (c) shows transfer time Tk (for example, 0.5 msec) in which the frame video data is transferred from the frame video data buffer 114 to the transmission frame video data buffer 211 and a video transmission period Tx (for example, 10.5 msec) in which the frame video data is transmitted to the video signal receiving apparatus 102. However, the actual transmission request information and the frame video data is transmitted/received by a transmission packet. Specifically, as shown in (d) in FIG. 5, the transmission request information 111a is transmitted by one video request packet PS (of which transmission time is, for example, 12 μsec), and the frame video data 121 is sent by 12 video data packets DP (each DP having transmission time of 110 μsec). Consequently, in the period Tj of one video frame of 33 msec, data can be transmitted/received by a plurality of packets, so that plural transmission request information and plural frame video data can be multiplexed and sent.

In the first embodiment shown in FIGS. 2 and 4, the operation has been described by the following method. The frame video data 121 from the camera 103a is recorded once on the frame video data buffer 114. When the transmission request 111a from the video signal receiving apparatus 102 is input to the controller 217, the frame video data 121 is read from the frame video data buffer 114 and stored in a vacant memory unit in the transmission frame video data buffer 211. However, the invention is not limited to the method. Obviously, by the control of the controller 217, the frame video data 121 from the video data converter 116 can be recorded in the frame video data buffer 114 and simultaneously in a vacant memory unit in the transmission frame video data buffer 211. By the latter method, in the case of distributing frame video data, transmission time can be shortened as compared with the case of reading the frame video data from the frame video data buffer 114 once, writing it to a vacant memory unit in the transmission frame video data buffer 211, and transmitting the frame video data.

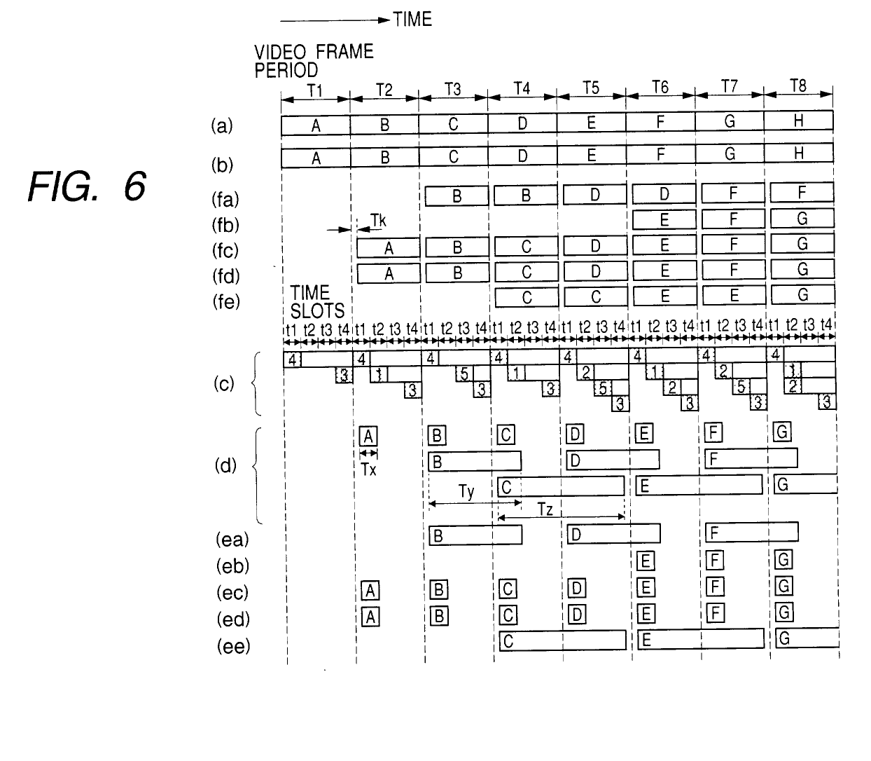

A second embodiment of the present invention will now be described by referring to FIG. 6. The embodiment shown in FIG. 6 relates to a case where m=n in the video transmission system shown in FIGS. 1 and 2. Specifically, it relates to the case where m pieces of memory units of the transmission frame video data buffer 211 in the video signal transmitting apparatus 200 are equal to n pieces (102a, 102b, . . . , and 102n) of the video signal receiving apparatus 102. Since the system configuration of the embodiment shown in FIG. 6 is similar to that shown in FIGS. 1, 2, and 3, the detailed description will not be repeated. The second embodiment will be described with reference to FIGS. 1, 2, 3, and 6.

In FIG. 1, it is assumed that the video signal transmitting apparatus 200a transmits/receives frame video data to/from the video signal receiving apparatuses 102a, 102b, . . . , and 102e. Similarly, to simplify the explanation of FIG. 6, the transmission request information 111a from the video signal receiving apparatuses 102a, 102b, . . . , and 102e is indicated by ID-1, ID-2, . . . , and ID-5 as shown by (c) in FIG. 6. Similarly, it is assumed that, as shown in (c) in FIG. 6, the transmission request information of the video signal receiving apparatuses 102a, 102b, and 102e is transmitted at predetermined timings in time slots t1, . . . , and t4 obtained by dividing the video frame period Tj into four parts, and a plurality of distribution requests of the transmission request information 111a are sent to the video signal transmitting apparatus 200a.

Therefore, the different points between explanation of the operation of FIG. 4 and that of FIG. 6 are that frame video data to be transmitted under control of the controller 217 in accordance with the transmission request information from the video signal receiving apparatuses 102a, 102b, . . . and 102e (five apparatuses in the embodiment) is stored in the memory units 211-1, 211-2, . . . , and 211-5, respectively. (fa), (fb), . . . , and (fe) in FIG. 6 illustrate the frame video data storing states in the memory units 211-1, 211-2, . . . , and 211-5. (d) in FIG. 6 shows transmission time according to a transmission band of a transmission path extending from the video signal transmitting apparatus 200 to the video signal receiving apparatus 102 as a transmission request source in accordance with the transmission request information 111a. Specifically, the transmission band of the band path to each of the video signal receiving apparatuses 102b, 102c, and 102d is sufficiently assured, and data is transmitted with the transmission time Tx. On the other hand, the transmission band to each of the video signal receiving apparatuses 102a and 102e is not sufficient and data is transmitted with transmission time Ty or Tz.

As the operation other than the different points is the same as that described in the first embodiment of the invention by referring to FIG. 1, the detailed description will not be repeated.

According to the second embodiment of the present invention, the transmission frame video data buffer 211 has the memory units of the same number as those of the video receiving apparatuses 102, and frame video data to be transmitted in correspondence with the video receiving apparatus 102 as the transmission request source is stored in each of the memory units. With the configuration, even in the case where data is transmitted to the video signal receiving apparatus 102 having transmission time equal to or longer than the period of one video frame in accordance with the transmission band of the transmission path extending from the video signal transmitting apparatus to the video signal receiving apparatus, the frame video data is held until the end of transmission, and the latest frame video data is stored in the memory unit corresponding to the video signal receiving apparatus 102 as the transmission request source, so that a process of transmitting the next frame video data can be addressed. Therefore, in a manner similar to the first embodiment of the invention, the video signal receiving apparatus can receive the latest frame video data every video frame period in accordance with the transmission band of the transmission path extending from the video signal transmitting apparatus to the video signal receiving apparatus, and optimum video reproduction with natural motion can be achieved.

Although the video signal generating source is a camera in the above description, the video signal generating source is not limited to the camera but may be any other devices such as VTR as long as it generates a video signal or video data.

Furthermore, in the above embodiments, the transmission video signal is described as frame video data, however, it may use field video data instead of the frame video data.

In the present invention, according to the transmission band of the transmission path extending from the video signal transmitting apparatus to the video signal receiving apparatus, the video signal receiving apparatus receives the latest frame video data every video frame period, so that a natural video with an optimum motion can be reproduced.

As described above, in the related art, due to influences of a transmission band assuring state and the order of accepting transmission requests in the video signal transmitting apparatus, sufficient video transmission cannot be performed. For example, if the video signal receiving apparatus for receiving frame video data in a cycle corresponding to the period of two video frames exists in the network, due to an influence of the video signal receiving apparatus, other video signal receiving apparatuses each having an assured transmission band cannot receive the latest frame video data, so that a video with an unnatural motion is resulted.

However, according to the present invention, when the transmission band is sufficiently assured, the video signal receiving apparatus can receive frame video data in a cycle corresponding to the period of one video frame. For example, according to the present invention, in the case where a camera supplies the latest frame video data, when the camera performs an operation such as panning or tilting to pick-up the latest video, the latest video is distributed to the video signal receiving apparatus. Therefore, the video signal receiving apparatus can receive and reproduce the latest frame video data in a cycle corresponding to the period of one video frame, so that a video with a natural motion can be obtained.

It will be appreciated while particular embodiments of the invention have been shown and described, modifications may be made. It is intended in the claims to cover all modifications which come within the true spirit and scope of the invention.

What is claimed is:

1. A video data transmission system for transmitting video data via a network, comprising:
at least one video signal transmitting apparatus for transmitting said video data to said network;
a network coupled with said video signal transmitting apparatus, for transmitting said video data; and
a plurality of video signal receiving apparatuses coupled with said network, for receiving said video data, wherein
said video signal transmitting apparatus comprising:
a first memory unit for storing said video data;
a second memory unit for storing said video data;
a plurality of transmitters for transmitting said video data stored in said first and second memory units to said network; and
a control unit for writing/reading the video data in said first and second memory units in accordance with a request of transmitting said video data from said video signal receiving apparatus, and controlling a transmitting operation of said plurality of transmitters.

2. A video data transmission system according to claim 1, wherein said video signal transmitting apparatus further comprises a video data converter for converting the video signal to digital video data, and
said digital video data from said video data converter is stored in said first memory unit in a vacant one of said second memory units.

3. A video data transmission system according to claim 2, wherein when said video signal transmitting apparatus receives a request of transmitting said digital video data from said at least one video signal receiving apparatus, said control unit of said video signal transmitting apparatus reads said digital video data stored in said second memory unit and controls said transmitter to transmit said digital video data to said video signal receiving apparatus which has sent said transmission request.

4. A video data transmission system according to claim 1, wherein said video signal transmitting apparatus further comprises a video data converter for converting a video signal to digital video data,
said digital video data from said video data converter is stored in said first memory unit, and said digital video data stored in said first memory unit is read and stored in a vacant memory unit in said plurality of second memory units.

5. A video data transmission system according to claim 4, wherein when said video signal transmitting apparatus receives a request of transmitting said digital video data from said at least one video signal receiving apparatus, said control unit of said video signal transmitting apparatus reads out said digital video data stored in said first memory unit, stores said digital video data in a vacant one of said plurality of second memory units, and controls said transmitter to transmit said digital video data to said video signal receiving apparatus which has sent said transmission request.

6. A video data transmission system according to claim 1, further comprising a camera unit coupled to said video signal transmitting apparatus,
wherein a video signal obtained from said camera unit is converted to digital video data by said video data converter and data recorded in said first memory unit is sequentially updated with said digital video data.

7. A video data transmission system according to claim 6, wherein said control unit updates data recorded in said second memory units in accordance with updating of the data recorded in said first memory unit except for said second memory unit which transmits digital video data to said video signal receiving apparatus.

8. A video data transmission system according to claim 7, wherein when the number of said video signal receiving apparatuses is n and the number of said second memory units is m, the relation of n>m>0 (where n and m are positive integers) is satisfied.

9. A video data transmission system according to claim 7, wherein the number of said video signal receiving apparatuses and the number of said second memory units are equal to each other.

10. A video data transmission system comprising a video signal transmitting apparatus for converting a video signal to video data and outputting said video data to a network, and a video signal receiving apparatus for receiving said video data from said network,
wherein said video signal transmitting apparatus stores said video data as frame video data into a first memory unit when a request of transmitting said frame video data is received from said video signal receiving apparatus, reads out the frame video data stored in said first memory unit, stores the read data into a vacant one of a plurality of second memory units, and transmits said frame video data to said video signal receiving apparatus which has sent said transmission request and,
when said frame video data is received, said video receiving apparatus sends a request of transmitting the next frame video data.

11. A video data transmission apparatus for transmitting video data via a transmission path, comprising:
a video data converter for converting a video signal to frame video data;
a first memory unit for storing said frame video data;
a second memory unit for storing said frame video data;
a plurality of transmitters for transmitting said frame video data stored in said first and second memory units to said transmission path; and
a control unit for writing/reading said frame video data in said first and second memory units in accordance with a request of distributing said frame video data from said transmission path, and controlling a transmitting operation of said plurality of transmitters.

12. A video data transmission apparatus according to claim 11, further comprising a video data converter for converting a video signal to said frame video data,
wherein said frame video data from said video data converter is stored in said first memory unit and in a vacant memory unit of said second memory unit and the stored data is sequentially updated.

13. A video data transmission apparatus according to claim 12, wherein when a request of transmitting said frame video data is received from said transmission path, said control unit reads out said frame video data stored in said second memory unit and controls said transmitter to transmit said frame video data to said transmission path.

14. A video data transmission apparatus according to claim 11, further comprising a video data converter for converting a video signal to frame video data,
wherein said frame video data from said video data converter is stored into said first memory unit and the stored data is sequentially updated, and
said control unit reads said frame video data stored in said first memory unit, stores the read data to a vacant one of said plurality of second memory units, and controls said transmitter to transmit said frame video data to said video signal receiving apparatus which has sent said transmission request.
